(19) United States
(12) Patent Application Publication
(10) Pub. No.: US 2012/0233192 A1
(43) Pub. Date: Sep. 13, 2012

(54) SYSTEM AND METHOD FOR PROVIDING ELECTRONIC BUSINESS CARDS BY SEARCHING STORAGE MEANS IN ACCORDANCE WITH ONE OR MORE CRITERIA

(75) Inventors: Francis Pinault, Courbevoie (FR); Jerome Elleouet, Brest (FR); Eric Bramoulle, Brest (FR)

(73) Assignee: Alcatel Lucent, Paris (FR)

(21) Appl. No.: 13/395,786

(22) PCT Filed: Aug. 10, 2010
(86) PCT No.: PCT/EP10/61612

§ 371 Date: May 29, 2012

(30) Foreign Application Priority Data
Sep. 14, 2009 (FR) 0956300

(51) Int. Cl. G06F 17/30; G06F 15/16

(52) U.S. Cl. 707/758; 707/E17.014

(57) ABSTRACT

A system (S) is dedicated to providing electronic business cards, comprising information related to people and to any positions that those people occupy within companies, to communication devices (EC1-EC3) connected to a communication network (RC). This system (S) comprises means of searching (MRP, MRS1-MRS3) operative to search within first means of storage (MS11-MS13), which store the aforementioned information as well as associated information display descriptions, each electronic business card that matches at least one chosen search criterion that is defined in an electronic business card request received from a communication device (EC1), and to provide that device (EC1) with each located electronic business card an that at least some of the information that it comprises can be displayed on a screen based on the display description associated with that information.

The invention relates to communication networks, and more specifically the providing of electronic business cards via wired or wireless communication networks.

Here, the term “electronic business card” refers to a set of digital data that defines the business card of a person who potentially works for a company (or corporation or group or business or administrative body).

Many people, particularly in professional settings, have actual business cards (generally made of paper) that they give out to other people whom they meet. Such a business card generally includes information such as a person's name, the business conducted by or position occupied by or department that includes that person, potentially a company's name, that person's (private or work) telephone number, that person's (private or work) e-mail address, and potentially the name and/or logo of the company for which that person works and/or that person's photograph. This information is written (or printed) in chosen locations, using one or more fonts and/or one or more character sizes and/or one or more colors, which define a style guide.

When the aforementioned people or companies wish to provide people in remote locations with their business cards, for example via a social network or via a communication network, they must have electronic business cards which are representative of their actual business cards and use an electronic business card transmission application. Unfortunately, known applications are only capable of transmitting the information of the business card and the logo if any, but not the style guide associated with that information. Consequently, whenever a person displays electronic business cards that he or she has received on the screen of his or her communication device, it is often difficult for him or her to quickly distinguish the information that they contain because they are displayed in the same format which does no abide by the style guides that had initially been associated with them.

Furthermore, the aforementioned method for providing electronic business cards does not enable a company to provide third parties, potentially via a social or professional network, with electronic business cards (potentially partial ones) of people who work for it (potentially chosen ones), based on a chosen style guide (potentially one that is different from its normal style guide).

The purpose of the invention is therefore to improve the situation.

To that end, it proposes a system dedicated to providing electronic business cards (comprising information relating to people and potentially to positions that those people occupy within companies) to communication devices connected to a communication network, and comprising means of searching tasked, firstly, with searching within first means of storage, which store the aforementioned information as well as associated information display descriptions, for each electronic business card that corresponds to at least one chosen search criterion defined within an electronic business card request received from a communication device, and secondly, to provide that communication device with each electronic business card found in view of displaying on a screen at least information that it comprises based on the display description that is associated with that information.

The inventive system may comprise other characteristics, which may be taken separately or in combination, in particular:
it may comprise a server accessible via the communication network, capable of receiving the electronic business card requests from communication devices, and comprising at least one so-called primary part of the means of searching operative to process the received request;
   the server may comprise translation means tasked with translating into a language that has been designated within a received request at least some of the information that is contained within a located electronic business card;
   its means of searching may comprise at least one so-called secondary part accessible to a communication address, and operative to search once a request has been received, in first means of storage (associated with at least one company and storing the electronic business cards of people that work for it), for each electronic business card that they store that matches at least one criterion defined in the request. In this case, the primary part of the means of searching may be operative to search within second means of storage, which store the communication addresses of each of the secondary parts as matches for company identifiers, for each communication address of each secondary part associated with a company designated within request for a person's (or people's) electronic business card(s);
      It may comprise the first means of storage associated with at least one company;
      It may comprise the second means of storage;
   it may comprise means of interconnection tasked with establishing a telephone communication between the communication device of a person who made an electronic business card request and at least one communication device of at least one person whose electronic business card was found by the means of searching;
it may comprise means of management operative to modify electronic business cards of people who work for at least one company and which are stored in third means of storage, as a function of a primary information-providing policy defined by that company;
   the means of management may be cast with storing the modified electronic business cards in first means of storage that are associated with that company;
   in one variant, the means of management may be tasked with storing the modified electronic business cards in fourth means of storage which are associated with at least one company;
      it may comprise means of selection tasked with selecting electronic business cards of people who work for at least one company and which are stored within fourth means of storage, based on a secondary information-providing policy that was defined by that company, and with storing the selected electronic business cards in first means of storage that are associated with that company;
   The search criteria, which are defined in the electronic business card requests, may be chosen from among (at least) belonging to a company, a person's name, a position occupied within the company, and a business conducted within a company.

The invention also proposes a method dedicated to providing electronic business cards (comprising information related to people and potentially to positions that these people occupy within companies) to communication device is connected to a communication network, consisting, in the event of an electronic business card request coming from a communication device:
i) of searching within the first means of storage (which store the information as well as associated information display descriptions) for each electronic business card corresponding to at least one chosen search criterion defined in that request, and
ii) of providing the communication device with each located electronic business card in view of displaying on a screen at least some of the information that comprises based on the display description that is associated with this information.

The method according to the invention can have other features, and in particular, separately or in combination:
in step i), after having located on electronic business card, at least some of the information that it contains may be translated into a language that has been designated in the received request;
it may comprise a step iii) consisting of establishing a telephone communication between the communication device of a person who has made an electronic business card request and at least one communication device of at least one person whose electronic business card has been located;
in step i) the electronic business cards of people who work for at least one company may be searched for from among electronic business cards that had previously been selected based on a secondary information-providing policy defined by that company.

Other characteristics and advantages of the invention will become apparent upon examining the detailed description below, and the attached drawings, wherein:

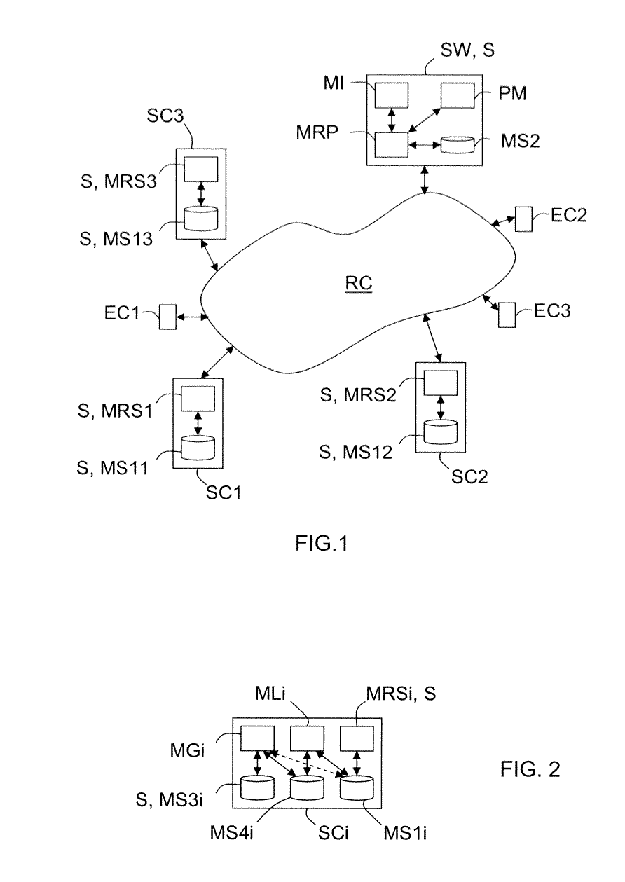

FIG. 1 very schematically and functionally depicts a communication network to which communication devices and a server and network equipment are connected, constituting one example embodiment of a system for providing electronic business cards according to the invention, and

FIG. 2 very schematically and functionally depicts one variant embodiment of a network device associated with a company and forming part of a system for providing electronic business cards according to the invention.

The appended drawings constitute part of the description of the invention as well as contributing to the definition of the invention, if necessary.

The object of the invention is to enable the provision of electronic business cards (potentially selected ones) that comply with a chosen style guide and whose information potentially abides by a chosen policy.

In what follows, it is assumed by way of non-limiting example that the electronic business cards belong to people who work for companies. However, the invention is not limited to this type of person. Rather, it pertains to both private and professional electronic business cards, so long as these electronic business cards comprise information which is associated with a style guide, or more generally speaking, with an information display description.

FIG. 1 schematically and functionally depicts a communication network RC to which communication devices ECj are connected, which are used by people (having an electronic business card), particularly to communicate.

It should be noted that the communication network RC may be wired or wireless. Consequently, the communication devices ECj (here j=1 to 3 by waiting non-limiting example) may be wired or wireless (or radio).

It should also be noted that FIG. 1 has only depicted a single communication network RC. However, this network (RC) potentially represents a set of communication networks interconnected with one another, and preferentially to the Internet.

In order to enable communication devices ECj to obtain electronic business cards, the invention proposes using a system S, one non-limiting example embodiment of which is depicted in FIG. 1.

A system S according to the invention comprises at least means of searching MRP and MRSk which are configured (or designed) to carry out searches within first means of storage MS1i that store information contained within electronic business cards as well as associated information display descriptions. These means of searching MRP and MRSk are more specifically, and particularly, tasked with searching within first means of storage MS1i for each electronic business card that matches at least one chosen search criterion that is defined within an electronic business card request received from a communication device ECj.

A request consists of a message (or request) that may, for example, comply with the SOAP protocol and which may, as a non-limiting example, be transmitted according to a transport protocol such as HTTP or SMTP.

It is important to note that in the example non-limiting embodiment depicted in FIG. 1, the first means of storage MS1i are distributed across devices located in different sites, which are respectively associated with different companies SCi (here 3, i=1 to 3). This is not obligatory, however. This is because first means of storage MS1i may store electronic business cards of people who work for different companies (at least two), or even for all companies who belong to the electronic business card providing service.

The first means of storage MS1i may come in any form known to the person skilled in the art, and particularly and as a non-limiting example in the form of a storage disk (for example with RAID configuration) configured in logical form in a database (for example, an SQL or ORACLE database).

It should be noted that the first means of storage MS1i do not necessarily so form part of the system S. In reality, what is important is that they are accessible to the means of searching MRP and/or MRSk.

The means of searching MRP and MRSk are also tasked with providing each located electronic business card to the communication device ECj that asked for them, so that at least some of the information that it comprises can be displayed on the screen according to the display description that is associated with that information. It should also be noted that the requesting communication device ECj may also potentially store each electronic business card that it finds, in view of later (re-)use.

Any type of search criteria, which may be designated (directly or indirectly) within an electronic business card request, may be used here. This way, it may, for example, involve belonging to a company or to a department of a company, or a person's name, or a position occupied within a company, or a business conducted within a company. Naturally, the same request may potentially comprise (or designated) multiple search criteria.

It should be noted that a search criterion may be defined by a word or phrase, or by an identifier, or by an audio file containing one or more search terms (in this situation, an “Automatic Speech Recognition” or ASR device may be provided).

As depicted in a non-limiting example, the means of searching MRP and MRSk may be subdivided into a so-called primary part MRP and at least one so-called secondary part MRSk, accessible to a communication address (for example, an IP address (‘Internet Protocol”)).

The primary part MRP of the means of searching is operative to process the requests received from the communication devices ECj. To do so, it (MRP) may, for example, be installed in a network device SW that is accessible to a known communication address via the communication network RC, which is capable of receiving electronic business card request(s) which are derived from communication devices ECj. This network device SW may, for example, be a service server or website that is connected to the Internet.

The primary part MRP is, for example, tasked with searching within second means of storage MS2, which store the communication addresses of each of the secondary parts MRSk as matches for identifiers of companies that subscribe to (or are members of) the service, for each communication address of each secondary part MRSk that is associated with a company that is designated in an electronic business card request received from a communication device ECj.

These second means of storage MS2 may come in any form known to the person skilled in the art, and particularly and as a non-limiting example in the form of a storage disk (for example with RAID configuration) configured in logical form in a database (for example, an SQL or ORACLE database). Furthermore, and as depicted in a non-limiting example, they may be co-located within the same network device SW as the one which is located within the primary part MRP of the means of searching. However, this is not mandatory.

It should be noted that the second means of storage MS2 do not necessarily form part of the system S. What is actually important is that they are accessible to the means of searching MRP.

When the primary part MRP has determined the communication address of each secondary part MRSk associated with a company SCi designated within a received request, it generates a request for each of these secondary parts MRSk based on the content of that received request, and in particular based on each search criterion that it contains or designates.

Each secondary part MRSk of the means of searching is operative to search within the first means of storage MS1i (associated with at least one company and storing electronic business cards of people who work for it), each electronic business card that they (MS1i) store and which match at least one request that was generated by the primary part MRP.

In the non-limiting example depicted, each company SCi has its own secondary part MRSk and its own first means of storage MS1i. Consequently, the indices i and k take on identical values (here i=k=1 to 3). However, this is not mandatory. This is because a secondary part MRSk may be associated with one or more different companies SCi, and therefore be tasked with carrying out searches in multiple different first means of storage MS1i or in first means of storage MS1i shared by multiple different companies SCi.

Whenever a secondary part MRSk has completed its search, it sends the primary part MRP a response message containing the results of that search, i.e. at least one electronic business card (meaning information about a person (potentially a selected one) as well as a display description (or style guide)), or a failure code if there was difficulty processing the request, or just an acknowledgment if the request could not find a result. Next, the primary part MRP sends the requesting communication device ECj each electronic business card located by each secondary part MRSk in view of displaying on a screen at least some of the information that it comprises according to the display description that is associated with that information.

For example, the found electronic business card, which is transmitted to a requesting communication device ECj, may come in the form of an XML (“eXtended Markup Language”) file. Such a file may, for example, have been created beforehand by merging a first file containing information about a person (for example, a VCF file) and a second file containing the display description of said information (or style guide) (for example, an XML file).

By way of example, the first information file comprises the last name (and first name) of the person in question, the name of the company for which that person works, the position occupied by that person within his or her company, that person's work telephone number, that person's work e-mail address, a photograph of that person, and that person's mailing address.

By way of example, the second style guide file comprises a background description (which is the same for all people who work for the company in question), the location and dimensions of the background, the logo of the company that the person in question works for, the location and dimensions of the logo, the location and dimensions of that person's photograph, and the respective locations, fonts, and character sizes of that person's name, the position occupied by that person, that person's work telephone number, that person's work e-mail address, and that person's mailing address.

It should be noted, as depicted in a non-limiting example in FIG. 1, that the server SW, and therefore the system S, may also and potentially comprise a translation module MT operative to translate into a language that has been designated in a previously received request at least some of the information that is contained within a located electronic business card and then must be conveyed to a requesting communication device ECj.

It should also be noted, as depicted in a non-limiting example in FIG. 1, that the system S may also potentially comprise, preferentially within its server SW, means of interconnection MI operative to establish a telephone communication between a requesting communication device ECj and at least one other communication device ECj′ of at least one person whose electronic business card has been located by the means of search MRP and MRSk. Such an Interconnection is carried out at the request of the requesting communication device ECj.

These means of interconnection MI may, for example, enable a person who made an electronic business card request whose telephone number and/or e-mail address had been deleted, to be able to establish a communication with the person who possesses that card, via the server SW.

It should also be noted, as depicted in a non-limiting example in FIG. 2, that the system S may also potentially comprise means of management MGi operative to modify electronic business cards of people who work for at least one company SCi. To do so, the means of management MGi may, for example, access third means of storage MS3i, in which are stored previously created (and not edited) electronic business cards. This access is intended to extract, upon the request of a person authorized by the company SCi in question, electronic business cards and must be modified based on a primary information-providing policy defined by that company SCi.

It should be understood that a company SCi might not want all of the information about its employees (contained within their full (and therefore unmodified) electronic business cards) to be available for communication to some (or all) outside persons. In this situation, the primary policy of the company SCi defines which information the company SCi agrees to make public.

As depicted in a non-limiting example in FIG. 2, the third means of storage MS3i may, for example, be distributed across different sites SCi which are respectively associated with different companies SCi. This is not obligatory, however. Rather, third means of storage MS3i could store the (unmodified) electronic business cards of people who work for different companies SCi (at least two), or even for all companies SCi that belong to the electronic business card provision service.

These third means of storage MS3i may come in any form known to the person skilled in the art, and particularly and as a non-limiting example in the form of a storage disk (for example with RAID configuration) configured in logical form in a database (for example, an SQL or ORACLE database).

It should be noted that the third means of storage MS3i do not necessarily form part of the system S. What is actually important is that they are accessible to the means of searching MGi.

As depicted in a non-limiting example in FIG. 2, the third means of storage MGi may, for example, be distributed across different sites SCi which are respectively associated with different companies SCi. This is not obligatory, however. Rather, means of management MGi could be operative to modify the electronic business cards of people who work for different companies SCi (at least two), or even for all companies SCi that belong to the electronic business card provision service.

Also depicted in a non-limiting fashion in FIG. 2 in dashes, the means of management MGi may potentially be operative to store each electronic business card that they have modified within the first means of storage MS1i, which are associated with the company SCi for which they operate. In one variant, also depicted in FIG. 2, the means of management MGi may potentially be operative to store each electronic business card that they have modified within the fourth means of storage MS4i, which are associated with at least one company SCi for which they operate.

These fourth means of storage MS4i may come in any form known to the person skilled in the art, and particularly and as a non-limiting example in the form of a storage disk (for example with RAID configuration) configured in logical form in a database (for example, an SQL or ORACLE database).

It should be noted that the fourth means of storage MS4i do not necessarily form part of the system S. What is actually important is that they are accessible to the means of searching MGi.

It should also be noted that the means of management MGi may also potentially be operative to enable an authorized person to create electronic business cards.

It should also be noted, as depicted in a non-limiting example in FIG. 2, that the system S may also and potentially comprise means of selection MLi operative to enable an authorized person to select electronic business cards of people who work for at least one company and which are stored in fourth means of storage MS4i. This selection is carried out based on a secondary information-providing policy which has been defined beforehand by the company SCi in question.

It should be understood that a company SCi might not want all of its employees' (full or modified) electronic business cards to be available for communication to some (or all) outside people. If so, a company's SCi secondary policy defines the names of the people whose (full or modified) electronic business cards may be made public.

As depicted in a non-limiting example in FIG. 2, the means of selection MLi may, for example, be distributed across different sites SCi which are respectively associated with different companies SCi. This is not obligatory, however. Rather, means of selection MLi could be operative to select the electronic business cards of people who work for different companies SCi (at least two), or even for all companies SCi that belong to the electronic business card provision service.

The means of selection MLi are also operative to store the electronic business cards that they have selected for an authorized person within the first means of storage MS1i which are associated with the company SCi for which they operate. This way, the electronic business cards which are stored within these first means of storage MS1i are those that the associated company SCi has allowed to be made public (and which therefore may be provided to requesting communication devices ECj).

The means of searching MRP and MRSk, as well as the translation modules MT, means of management MGi and means of selection MLi if any, may be constructed in the form of software (or computer) modules. However, they may also be constructed in the form of electronic circuits or a combination of electronic circuits and software modules, potentially forming part of network components that are servers.

It is important to note that the invention may also be considered from the perspective of a method for providing electronic business cards, which may particularly be implemented by means of a system S of the type presented above. As the functionalities provided by the implementation of the method according to the invention are identical to those provided by the system S introduced above, only the combination of the main functionalities provided by the so method is presented hereafter.

This method consists, in the event of an electronic business card request from a communication device ECj:
i) of searching within the first means of storage MS1i, which store the information related to people and to any positions that those people occupy within companies as well as associated information display descriptions, for each electronic business card that matches at least one chosen search criterion defined within the request, and
ii) of providing the requesting communication device ECj with each located electronic business card in view of displaying on a screen at least some of the information that it comprises based on the display description that is associated with this information.

The invention is not limited to the embodiments of the system and method for providing as described above, which are given only by way of example; rather, it encompasses all variants a person skilled in the art may envision within the scope of the claims set forth below.

1. A system (S) for providing electronic business cards, comprising information related to people and to any positions that those people may occupy within companies, to communication devices (ECj) connected to a communication network (RC), wherein it comprises means of searching (MRP, MRSk) operative to search within first means of storage (MS1i), which store said information as well as associated information display descriptions, for each electronic business card matching at least one chosen search criterion defined within an electronic business card request received from a communication device (ECj), and to provide that communication device (ECj) with each located electronic business card in view of displaying on a screen at least some of the information that comprises in accordance with the display description associated with said information.

2. A system according to claim 1, wherein it comprises a server (SW) accessible via said communication network (RC), capable of receiving said electronic business card requests from said communication devices (ECj), and comprising at least one so-called primary part (MRP) of said means of searching operative to process said received requests.

3. A system according to claim 2, wherein said server (SW) comprises means of translation (MT) operative to translate into a language designated within a received request at least some of the information contained within a located electronic business card.

4. A system according to claim 2, wherein said means of searching (MRP, MRSk) comprise at least one so-called secondary part (MRSk) accessible at a communication address, and operative to search when a request is received within first means of storage (MS1i), associated with at least one company and storing electronic business cards of people who work for it, for each electronic business card that they store that matches at least one criterion defined within said request, and in that said primary part (MRP) of the means of searching is operative to search within second means of storage (MS2), which store the communication addresses of each of the secondary parts (MRSk) as matches of company identifiers, for each communication address of each secondary part (MRSk) associated with a company designated within a request for peoples' electronic business card(s).

5. A system according to claim 1, wherein it comprises said first means of storage (MS1i) associated with at least one company.

6. A system according to claim 4, wherein it comprises said second means of storage (MS2).

7. A system according to claim 2, wherein it comprises means of interconnection (Ml) operative to establish a telephone communication between the communication device (ECj) of a person who has made an electronic business card request and at least one communication device (ECj′) of at least one person whose electronic business card has been located by said means of searching (MRP, MRSk).

8. A system according to claim 1, wherein it comprises means of management (MGi) operative to modify electronic business cards of people who work for at least one company and which are stored within third means of storage (MS3i), based on a primary information-providing policy defined by said company.

9. A system according to claim 8, wherein said means of management (MGi) are operative to store said modified electronic business cards in first means of storage (MS1i) associated with that company.

10. A system according to claim 8, wherein said means of management (MGi) are operative to store said modified electronic business cards in fourth means of storage (MS4i) associated with at least one company.

11. A system according to claim 10, wherein it comprises means of selection (MLi) operative to select electronic business cards of people who work for at least one company and which are stored in the fourth means of storage (MS4i), based on a secondary information-providing policy defined by said company, and to store said selected electronic business cards in first means of storage (MS1i) associated with that company.

12. A system according to claim 1, wherein said search criteria, defined in electronic business card requests, are chosen from a group comprising at least belonging to a company, a person's name, a position occupied within the company, and a business conducted within a company.

13. A method for providing electronic business cards, comprising information related to people and to any positions that those people occupy within companies, to communication devices (ECj) connected to a communication network (RC), wherein it consists, in the event of an electronic business card request from a communication device (ECj):
i) of searching within first means of storage (MS1i), which store said information as well as associated information display descriptions, for each electronic business card corresponding to at least one chosen search criterion defined in said request, and
ii) of providing to said communication device (ECj) with each located electronic business card in view of displaying on a screen at least some of the information that it comprises based on the display description that is associated with said information.

14. A method according to claim 13, wherein in step i), after an electronic business card is found, at least some of the information that it contains is translated into a designated language.

15. A method according to claim 13, wherein it comprises a step iii) consisting of establishing a telephone communication between the communication device (ECj) of a person who made an electronic business card request and at least one communication device (ECj′) of at least one person whose electronic business card has been located.

16. A method according to claim 13, wherein in step i), electronic business cards of people who work for at least one company are searched for from among electronic business cards previously selected based on a secondary information-providing policy defined by said company.

17. A method according to claim 13, wherein said search criteria, defined in electronic business card requests, are chosen from a group comprising at least belonging to a company, a person's name, a position occupied within the company, and a business conducted within a company.
